(19) United States
(12) Patent Application Publication
(10) Pub. No.: US 2013/0001364 A1
(43) Pub. Date: Jan. 3, 2013

(54) HELICOPTER WITH REMOVABLE FUEL TANK

(75) Inventors: Per-Erik Cardell, Linkoping (SE); Kjell Stenbom, Norrkoping (SE)

(73) Assignee: SAAB AB, Linkoping (SE)

(21) Appl. No.: 13/513,691

(22) PCT Filed: Dec. 2, 2009
(86) PCT No.: PCT/SE2009/051361

§ 371 Date: Aug. 15, 2012

(51) Int. Cl. B64D 37/04; B64F 1/28

(52) U.S. Cl. 244/135 R

(57) ABSTRACT

Helicopters with removable fuel tanks Each fuel tank is a removable fuel tank. Each fuel tank is removable and can safely be stored on ships and aircraft carriers.

The invention relates to helicopters with removable fuel tanks.

### BACKGROUND OF THE INVENTION

Unmanned aerial vehicle (UAV) helicopters are employed mainly for exploration purposes. UAV helicopters are often operated from ships or aircraft carriers. In many cases, very strict regulations apply when storing and/or operating vehicles with easily inflammable fuel on board of such ships or aircraft carriers, in particular, if such vehicles are to be stored under deck. In other cases, such vehicles must be stored away in certain designated areas, which are, e.g., ventilated or otherwise suitable for storing flammable objects. When unmanned helicopters are to be operated from ships or aircraft carriers, it is thus often required that fuel tanks of such helicopters are emptied, prior to storing the helicopters under deck. Sometimes the fuel tanks are flushed or filled with an inert gas, such as nitrogen, prior to storage. This is very labor intensive, time consuming and costly.

The present invention seeks to overcome these problems by the provision of a helicopter, all fuel tanks of which are removable, and can quickly and conveniently be detached from the helicopter, prior to storing the helicopter. The fuel tanks removed from the helicopter can then be separately stored in suitable designated storage areas for flammable objects.

Removable fuel tanks per se are known.

A mounting system for auxiliary fuel tanks is known from U.S. Pat. No. 6,149,102. This mounting system includes a restraint pan into which an auxiliary fuel tank is placed, a harness extending over the fuel tank, and a pair of brackets each having a corner receptacle for engaging a corner of the fuel tank. The auxiliary fuel tank can be easily installed or removed in order to re-configure a helicopter as quickly as possible; e.g. in ten minutes or less. The helicopter, however, also comprises non-removable main fuel tank and can thus not easily be stored on a ship.

U.S. Pat. No. 6,123,495 describes a device for moving and loading an auxiliary fuel tank which includes a U-shaped chassis frame supported on wheels and a lift frame vertically movable within the chassis such that the lift frame can rest on the ground and move above the chassis frame. A plurality of winches is located on the lift frame and is driven in common through a step-down gear mechanism powered by a hand crank.

### SUMMARY OF THE INVENTION

The present invention relates to a helicopter comprising a fuselage and at least one fuel tank, wherein all of said at least one fuel tanks of said helicopter are removable.

Due to the removability of all fuel tanks from the helicopter, the helicopter (without the fuel tanks) can be stored in areas where storage of flammable materials is normally not allowed.

Preferred helicopters of the invention are unmanned aerial vehicle (UAV) helicopters.

Helicopters of the invention preferably include a fuselage having an outer surface, wherein all fuel tanks of the helicopter are mounted external to said outer surface of the fuselage. None of the fuel tanks of the helicopter is thus in the fuselage, i.e., under an outer surface of the fuselage.

Preferably, at least one of the fuel tanks is adapted to fit into a corresponding recessed portion (recess) of the outer surface of the fuselage. Placing fuel tanks in recessed portions of the outer surface of the fuselage allows for easy access to, and quick mounting and demounting of, the fuel tank. In particular, no parts of the fuselage body need to be removed prior to mounting or dismounting of the fuel tanks.

Preferably, an outer surface of at least one fuel tank, or all fuel tanks, align(s) with the non-recessed portions of the outer surface of the fuselage. Preferably, the fuel tank(s) do not protrude from the fuselage. This is aerodynamically preferred, because the original outer shape of the helicopter, which is optimized for aerodynamic properties, is maintained.

The fuel tanks preferably comprise a fuel inlet port.

The helicopter may comprise two fuel tanks, wherein these fuel tanks are mounted on opposite sides of the fuselage. This results in a favorable weight distribution.

Preferably, the two fuel tanks stand in fluid communication with each other. This allows moving fuel from one tank to the other to equalize the load on both sides of the helicopter.

In a preferred embodiment of the invention, at least one fuel tank comprises, or all fuel tanks comprise, at least one stud for co-operation with a corresponding guide rail in the recessed portion of said outer surface of said fuselage. This allows guiding the movement of the fuel tank when the fuel tank is mounted or dismounted to or from the helicopter. The stud, in co-operation with the guide rail can also fix the fuel tank in the recessed portion, if the guide rail is appropriately shaped, e.g. arch shaped.

The stud may comprise a wheel or a caster, to reduce friction when the stud is moved along the guide rail, in particular, when the fuel tank is full and heavy.

The fuel tanks may comprise locking means for locking said fuel tanks in the corresponding recessed portions. The locking means are preferably releasable locking means. The releasable locking means may comprise snap fit locking means, a latch, or a tripping gear locking mechanism.

In one embodiment of the invention, at least one fuel tank comprises a handle on its outer surface. This allows to grip the fuel tank when dismounting the same from the fuselage.

Preferably, at least one the fuel tank comprises, or all fuel tanks comprise, fuel connectors for connection with corresponding fuel connectors provided in said recessed portions of the outer surface of the fuselage. The fuel connectors may comprise fuel valves. The fuel valves may be self-locking fuel valves.

In a further embodiment, at least one the fuel tank comprises, or all fuel tanks comprise, electrical connectors for connection with corresponding electrical connectors provided in the recessed portions of the outer surface of the fuselage.

The invention further relates to a method of storing a helicopter, e.g. on a ship, preferably under the deck of a ship, said method comprising removing all fuel tanks of said helicopter, e.g., before storing said helicopter under deck.

The fuel tanks, according to the invention, can preferably be mounted or dismounted in less than 60 seconds.

### BRIEF DESCRIPTION OF THE DRAWINGS

FIG. 1 shows a helicopter comprising a removable fuel tank.

FIG. 2 shows a guide rail.

FIG. 3 shows the rear side of the removable fuel tank.

FIG. 4 shows the front side of the removable fuel tank.

FIG. 5 shows the recessed portion (or recess) within the outer surface of the fuselage for inserting the removable fuel tank.

FIG. 6 shows an alternative embodiment for mounting a removable fuel tank to the helicopter.

FIG. 7 shows a helicopter with an alternative fuel tank attachment construction to the fuselage of the helicopter.

### DETAILED DESCRIPTION OF THE INVENTION

The present invention relates to helicopters all fuel tanks of which are removable from the helicopter. Helicopters of the invention are preferably unmanned aerial vehicle helicopters (UAV).

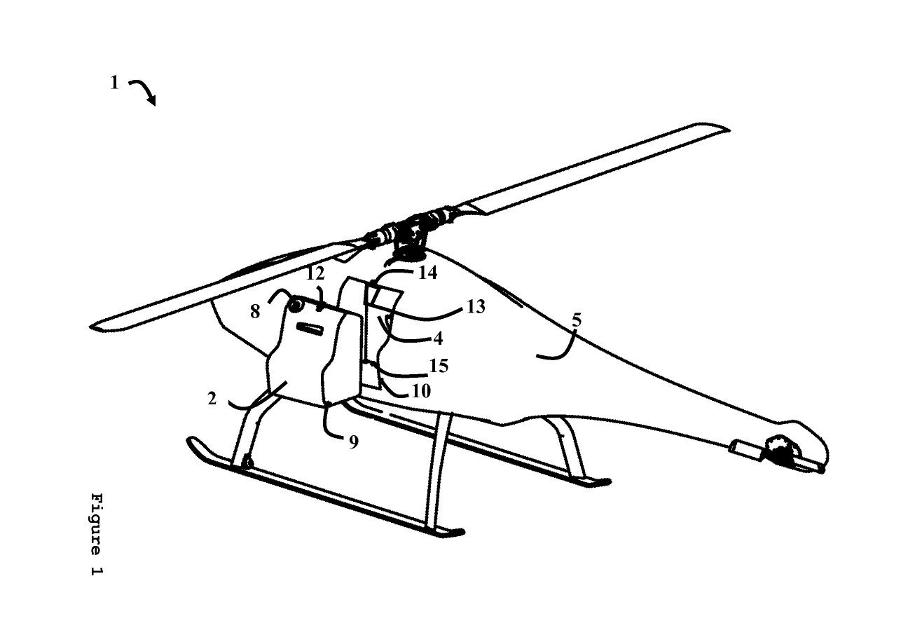

In the embodiment shown in FIG. 1, helicopter 1 comprises fuselage 5 and one removable fuel tank 2. All fuel tanks of the helicopter are removable.

The fuel tanks are preferably removable by hand only, i.e., without requiring the use of tools, such as a screwdriver or a wrench.

Fuel tanks of present invention comprise releasable locking means. The releasable locking means are preferably quick release means. Quick release means allow release of a fuel tank from the fuselage with or without requiring the use of tools. Quick release means allowing release of the tank without requiring the use of tools are preferred.

The locking means preferably allow for quick removal of the removable fuel tank 2 from the helicopter 1. Releasable locking means of fuel tank 2 preferably do not require the use of any additional tools e.g. wrenches.

In one embodiment of present invention the locking means allow the detachment of the removable fuel tank 2 in a relatively short period of time, in the range of some minutes, preferably less than 1 minute, or less than 10 minutes.

FIG. 1 shows a fuel tank and a fuselage with a recessed portion 4 in which the fuel tank 2 can be countersunk.

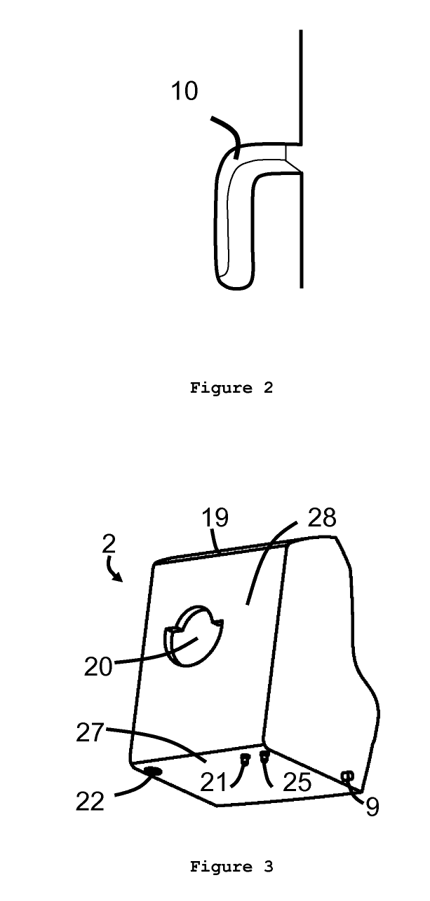

Recess 4 can have two alternative constructions. One embodiment of recess 4 provides guide rails 10 which facilitates the docking process of removable fuel tank 2 into recessed portion 4. As shown in FIG. 2, guide rails may be formed as an arch which provides for a horizontal and vertical movement of removable fuel tank 2 when being introduced into recess 4. The vertical part of the guide rail effects locking of the fuel tank in its final position, by virtue of the gravitational forces. The locking is preferably such that fuel valve connectors 21, 25 of the fuel tank engage to fuel valve connector 15 of the fuselage (see FIGS. 1 and 3). The vertical movement can additionally be used for connecting electrical connector 22. The fuel valve connectors 21, 25 and electrical connector 22 are preferably attached on the bottom 27 of removable fuel tank 2.

Alternatively, guide rails 10 may incorporate rolling elements (or wheels). Guide rails 10 are preferably of light metal or alloys, e.g., aluminum or light synthetic materials (such as PVC).

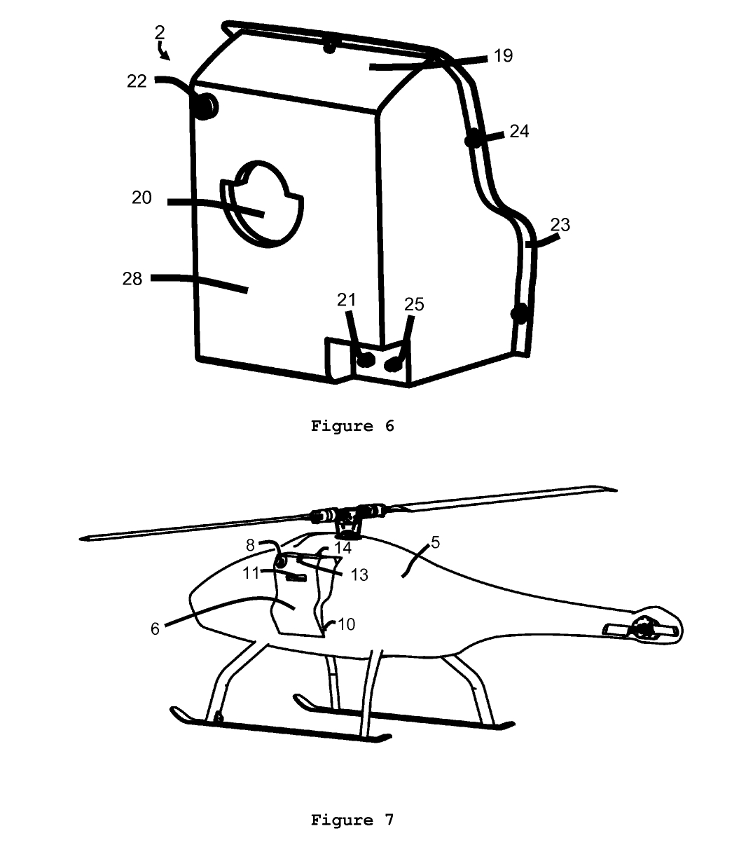

Alternative embodiments of recess 4 have no guide rails or have straight horizontal guide rails. The docking procedure of fuel valve connectors 15, 21, 25 and electrical connector 22 is then accomplished by applying horizontal force. In this case, fuel valve connectors 21, 25 and the electrical connector 22 would best be attached to the rear side 28 of removable fuel tank 2 (as shown in FIG. 6).

An advantage of the insertion of the removable fuel tank 2 in a recess 4 is that it improves the aerodynamic properties and shape of helicopter 1. Additionally, the weight distribution of loads on the helicopter is improved.

Another example of mounting removable fuel tank 2 to helicopter 1 is to dock removable fuel tank 2 externally to an outer surface of fuselage 5, wherein the outer surface is not recessed. In this case removable fuel tank 2 protrudes from the fuselage of helicopter 1.

The fuel tank assembly may comprise two removable fuel tanks 2, one removable fuel tank mounted on each side of fuselage 5 of helicopter 1. Each removable fuel tank 2 in this arrangement may be removably connected to a fuel pipe via fuel valve connector 15. The fuel pipes to/from each removable fuel tank 2 may either stand in fluid communication with each other or may be separately connected to the engine. When the removable fuel tanks stand in fluid communication with each other, then the removable fuel tanks can maintain approximately the same weight while fuel is used, and they will be emptied at the same time. Alternatively, the removable fuel tanks docked to helicopter 1 may be separately connected to the engine so that one fuel tank after the other is emptied.

At the rear side and/or at the bottom side of removable fuel tank 2, two fuel valve connectors 21 and 25 are provided. Fuel valve connector 21 comprises a fuel outlet drain to the engine, and fuel valve connector 25 may allow intake of fuel which is returned from the engine.

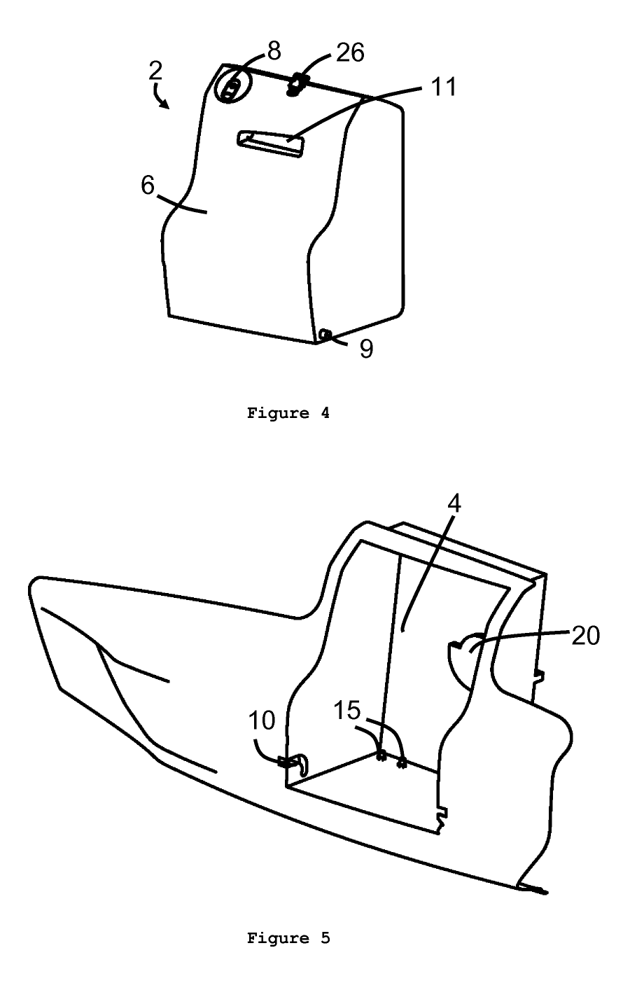

Removable fuel tank 2 depicted in FIGS. 3 and 4 comprises a fuel inlet port 8 on the outer surface 6 of the removable fuel tank 2. The fuel inlet port 8 allows filling of the removable fuel tank 2 while fuel tank 2 is mounted to the helicopter. Tank 2 can also be filled when it is in a tilted position, or when it is dismounted.

As shown in FIGS. 3 and 4, removable fuel tank 2 comprises studs 9 to facilitate the mounting of the removable fuel tank 2 through guide rails 10, provided in recess 4 of helicopter 1. A method of mounting the removable fuel tank 2 to helicopter 1 comprises lifting the removable fuel tank 2, while being in a tilted position, towards the fuselage 5 of helicopter 1, so that studs 9 of the fuel tank 2 are countersunk into guide rails 10 of recess 4.

Studs 9 may also include wheels, casters or rollers, which reduce friction when studs 9 are moved along guide rails 10. While the upper part of the outer surface 6 of the removable fuel tank 2 is tilted towards fuselage 5 of the helicopter 1 studs 9 of removable fuel tank 2 are moving along guide rails 10 until studs 9 have reached the lower end of guide rails 10. In the mounted condition, the outer surface 6 of removable fuel tank 2 preferably aligns with the fuselage casing of helicopter 1.

Alternatively fuel tank 2 may protrude from the fuselage 5 (see FIG. 7). Such protruding tanks can normally store a slightly larger volume of fuel.

For removing fuel tank 2, the steps are performed in the opposite order.

In an alternative embodiment, guide rails 10 may be provided at the removable fuel tank 2, and studs 9 may be provided in recessed portion 4.

In a further embodiment the fuel tank may be provided with casters or rollers mounted on the bottom 27 of removable fuel tank 2, e.g. for convenient transport of the fuel tank from/to fuel re-fill stations, and movement in recessed portions 4.

As shown in 3, fuel valve connectors 21 and 25 and electrical connector 22 are provided at the bottom side 27 of fuel tank 2.

An alternative embodiment of the configuration of fuel valve connectors 21, 25 and electrical connector 22 is shown in FIG. 6. Fuel valve connectors 21, 25 and electrical connector 22 are provided at the rear side of fuel tank 2. In this case, recess 4 may have either straight horizontal guide rails or no guide rails at all.

Fuel valve connectors 15, 21 and 25 are preferably of the self-locking type. When removable fuel tank 2 is mounted into recess 4 the self-locking fuel valve connectors 21 and 25 are docked to fuel valve connector 15 which may be part of the fuel pipeline within the helicopter. Fuel valve connectors 15, 21 and 25 may comprise hydraulic valves, check valves or plastic valves. Other valve types are conceivable. When the fuel valve connectors 21 and 25 are plugged into fuel valve connector 15, an internal pressure-tight seal of fuel valve connectors 15, 21 and 25 is provided. When removing removable fuel tank 2, fuel valve connectors 21 and 25, attached to removable fuel tank 2 are undocked from fuel valve connector 15 and fuel leaking is prevented by self-locking fuel valve connectors 15, 21 and 25.

Electrical connector 22 connects electronic means located inside of removable fuel tank 2, with the main electronic unit of helicopter 1. Electrical connector 22 transmits at least one electronic signal from/to electronic means to/from the main electronic unit. The electronic means can be one of a fuel level indicator, a fuel consumption measuring unit, a fuel flow rate measuring device and a pressure sensing unit. It is conceivable that other electronic devices are installed in removable fuel tank 2. Electrical connector 22 preferably establishes a releasable electric connection between removable fuel tank 2 and the electric counterpart of electrical connector 22 installed at recess 4.

Quick mounting and removing of fuel tank 2 is facilitated by releasable locking means 13 which comprises two parts. One part of locking means 13 may be a latching means 12 provided on fuel tank 2. Latching means 12 may comprise a simple notch at the upper part of fuel tank 2. The other part of locking means 13 may comprise a locker, preferably provided in recess 4.

Locking means 13 may comprise a locker-striker-plate that interlocks with latching means 12. The locking means is preferably provided in recess 4. The locker-striker-plate snaps into latching means 12 of removable fuel tank 2. A spring preferably holds the locker-striker-plate in place.

The provision of a handle 11 may support the unmounting of fuel tank 2 out from recess 4. Handle 11 is preferably attached to the outer surface 6 of removable fuel tank 2. Additionally, other handles may be provided at removable fuel tank 2 for transportation purposes. Other handles may be provided at removable fuel tank 2, e.g. to each side of removable fuel tank 2 which facilitates transport of the removable fuel tank 2 when carried by two persons.

Another locking mechanism for docking removable fuel tank 2 to recess 4 can be seen in FIG. 6. Removable fuel tank 2 may comprise a flange 23 on its outer rim. The flange 23 comprises quick release fasteners 24. After docking the removable fuel tank 2 to recess 4, quick release fasteners 24 may be actuated either by hand or by a tool. Quick release fasteners 24 preferably are one of bayonet joints, quick release ball lock pins, quarter turn fasteners, tension latches, push turn fasteners, shear pin latches, quick release pins or livelock panel fasteners.

In conjunction with the locking means 13 a locking indicator may be provided. The locking indicator indicates if the removable fuel tank 2 is correctly mounted into bay 4 of fuselage 5 of helicopter 1. For example, the locking indicator may comprise light emitting diodes (LED), which signalize, e.g. by a green flashing LED, that the removable fuel tank 2 is correctly fitted into recess 4. A red LED may indicate that removable fuel tank 2 is not correctly fitted in recess 4 of the helicopter. In case that removable fuel tank 2 is fully removed from recess 4, a red LED may be activated.

As shown in FIG. 6 damping means 20 are provided on the rear side 28 of the removable fuel tank 2. Damping means 20 may comprise a counterpart mounted in recess 4 of fuselage 5. Damping means 20 provide for mechanical de-coupling of the oscillating parts of the helicopter from the removable fuel tank, in order to avoid damage and/or wear of the fuel tank.

1. A helicopter, comprising:
a fuselage has comprising an outer surface, and at least one fuel tank, wherein each fuel tank is removable wherein each fuel tank is adapted to fit into corresponding recessed portions of the sides of the fuselage, and wherein one outer surface of each of said fuel tank aligns with non-recessed portions of the outer surface of said fuselage, so as to not to protrude from the fuselage.

2. The helicopter according to claim 1, wherein said helicopter is an unmanned helicopter.

3. The helicopter according to claim 1, wherein each fuel tank is mounted external to said outer surface of said fuselage.

4. The helicopter according to claim 1, wherein said at least one fuel tank comprises a fuel inlet port.

5. The helicopter according to claim 1, wherein two fuel tanks are mounted on opposite sides of said fuselage.

6. The helicopter according to claim 5, wherein said two fuel tanks stand in fluid communication with each other.

7. The helicopter according to claim 1, wherein said at least one fuel tank comprises at least one stud, for co-operation with a corresponding guide rail in a recessed portion of said outer surface of said fuselage.

8. The helicopter according to claim 7, wherein said stud comprises a wheel.

9. The helicopter according to claim 1, wherein each fuel tank comprises a lock configured to lock said all fuel tanks in said corresponding recessed portions of said outer surface.

10. The helicopter according to claim 1, wherein said at least one fuel tank comprises a handle on an outer surface.

11. The helicopter according to claim 1, wherein said at least one fuel tank and said recessed portions each comprise fuel valve connectors and/or electrical connectors.

12. The helicopter according to claim 11, wherein said fuel valve connectors are self-locking valve connectors.
